(19) United States
(12) Patent Application Publication
(10) Pub. No.: US 2022/0039324 A1
(43) Pub. Date: Feb. 10, 2022

(54) A method for treating a plant material

(71) Applicant: OPTIFREEZE AB, LUND (SE)

(72) Inventors: Eda DEMIR WESTMAN, LUND (SE); Katarzyna Maria DYMEK-KRAKOWIAK, LUND (SE); Maria HELLSTRÖM, LOMMA (SE)

(21) Appl. No.: 17/312,928

(22) PCT Filed: Dec. 10, 2019
(86) PCT No.: PCT/SE2019/051258

§ 371 Date: Jun. 10, 2021

(30) Foreign Application Priority Data
Dec. 11, 2018 (SE) 1851543-7

(51) Int. Cl. A01G 7/04; A01G 7/06

(52) U.S. Cl. CPC A01G 7/04; A01G 7/06

(57) ABSTRACT

The present invention describes a method for treating a plant material, said method comprising the following steps: —exposing the plant material to vacuum impregnation in an aqueous solution; —applying a pulsed electrical field (PEF) treatment to the plant material in the aqueous solution before, simultaneously as or after exposing the plant material to vacuum impregnation in an aqueous solution; —applying a drying step to the PEF treated plant material for removing water/moisture from surfaces of the plant material before packing the treated plant material; said method also comprising an active step for preventing microbial contamination of the aqueous solution.

### FIELD OF THE INVENTION

The present invention relates to a method for treating a plant material, said method involving a PEF (pulsed electrical field) treatment step.

### TECHNICAL BACKGROUND

Plant material methods involving a PEF treatment step are known. For instance, in WO 2016/153413 there is disclosed an apparatus and a method for extending shelf life of a biological soft tissue, said method comprising the steps of introducing one or more cell protecting agents into the extracellular and intracellular space of the biological soft tissue, and extended cold storing of the biological soft tissue intended for preservation of the same, and where the method also comprises rinsing the biological soft tissue before or after the introducing of one or more cell protecting agents into the extracellular and intracellular space of the biological soft tissue.

Furthermore, in WO 2017/176201 there is disclosed a method for treatment of biological soft tissue, wherein the method comprises a step involving pulsed electric field (PEF) treatment to open up the stomata in tissues by electroporation of guard cells, and also a subsequent drying step, where the PEF treatment is performed in an electrical field with a field strength in the range of 0.4-1.5 kV/cm to provide enhanced rate of moisture removal during dehydration without irreversible damage on epidermal cells, where the PEF treatment is performed with reversible electroporation and where the temperature in the drying step is held within the range of 20-55° C.

One aim of the present invention is to provide an improved method for treating a plant material where the method involves a PEF treatment step and where the method provides an improved preservation of plant material, especially of flower type materials.

### SUMMARY OF THE INVENTION

The stated purpose above is achieved by a method for treating a plant material, said method comprising the following steps:

exposing the plant material to vacuum impregnation in an aqueous solution;
applying a pulsed electrical field (PEF) treatment to the plant material in the aqueous solution before, simultaneously as or after exposing the plant material to vacuum impregnation in an aqueous solution;
applying a drying step to the PEF treated plant material for removing water/moisture from surfaces of the plant material before packing the treated plant material;
said method also comprising an active step for preventing microbial contamination of the aqueous solution.

In relation to the above it should be mentioned that the expression “plant material” also embodies only a part or piece of a plant material. Therefore, the method according to the present invention is also directed to treating only a part of a plant material, such as only a part of a cutting or a part of a stem or only a flower, or any such combination without treating the entire plant material object. It should of course be noted that the method according to the present invention also embodies to treat entire plant material objects, such as cuttings of different types.

The present invention involves an active step for preventing microbial contamination of the aqueous solution, which active step can take different forms as discussed below. This active step for preventing microbial contamination implies the prevention of growth and accumulation of microspores. This is very important when treating a flower plant material to prolong the shelf life of the same. As understood from below in the section of specific embodiments, this active step according to the present invention may be of a different type. Moreover, it should be noted that the active step for preventing microbial contamination according to the present invention in fact may be performed during, before or after different steps of the method. As one example, the control of prevention of microbial contamination may be performed during the vacuum impregnation step. In another example, this control is performed during both the PEF step and the vacuum impregnation step.

The steps of vacuum impregnation and applying PEF can be performed in different ways. Furthermore, this is also true for the drying step performed subsequently to the vacuum impregnation and PEF treatment. For instance, air blowing may be used. Also shaking techniques may be used for the drying step to ensure to remove water from the surfaces. Some other alternatives for these vacuum impregnation, PEF treatment and drying steps are also described in WO 2016/153413 and WO 2017/176201.

In relation to the vacuum impregnation, a somewhat higher minimum pressure may be beneficial according to the present invention. According to one specific embodiment of the present invention, the minimum pressure is above 100 mbar, preferably above 200 mbar, such as e.g. around 300 mbar. Furthermore, it should be noted that when a specific pressure range is used, the higher level inside that range may be beneficial. A higher minimum pressure may be preferred to obtain partial impregnation instead of a full impregnation, which may be an advantage. Partial impregnation is further explained below.

Moreover, as noted above, the method according to the present invention involves a drying step to the PEF treated plant material for removing water/moisture from surfaces of the plant material before packing the treated plant material. To remove the water/moisture from the surfaces ensures a prolonged shelf life for the treated material according to the present invention. Furthermore, although different drying techniques are possible in the method according to the present invention it is important to ensure that the surfaces are dried enough to remove some or most of the moisture thereon after the PEF treatment and vacuum impregnation. In relation to the drying step, this may be an active drying step, such as disclosed above, however also packing the plant material in an environment with controlled humidity is a possibility according to the present invention. Also this alternative should be regarded as a drying step according to the present invention.

### SPECIFIC EMBODIMENTS OF THE INVENTION

Below some specific embodiments of the present invention are discussed.

According to one embodiment of the present invention the active step for preventing microbial contamination involves adding one or more antimicrobial agents to the aqueous solution. When treating flower materials, it is important to ensure to prevent microbial contamination of the aqueous solution. The present invention solves this issue.

The antimicrobial agents used may be of different type. According to one specific embodiment of the present invention, the antimicrobial agent is any of one or more fungicides, bactericides, compounds changing the pH of aqueous solution used, e.g. acids or bases, or organic or inorganic antiseptic or disinfectant compounds, or any combination thereof.

Moreover, the aqueous solution used may be of different types according to the present invention. Non-limiting examples are different substances, such as aqueous solutions comprising glucose, trehalose or combinations thereof. Also other sugar alternatives are possible, such as solutions comprising sucrose, mannitol or fructose. Also other alternatives are possible, such as glycerol.

As should be understood from above, different types of substances may be used in the aqueous solution as an effective vacuum impregnation solution according to the present invention. According to one specific embodiment of the present invention, the aqueous solution comprises at least one additive of folic acid, gamma-aminobutyric acid (GABA), ethylene blockers, e.g. 1-methylcyclopropene (1-MCP), amino acids, e.g. cysteine, plant hormones, e.g. IBA, an antiseptic agent, e.g. silver nitrate, or a combination thereof. Other examples are calcium lactate or potassium sorbate. The one or several used above are suitably admixed with one or more sugars in the solution.

Moreover, also the steps as such may vary in its execution. For instance, the impregnation step as such may involve a partial impregnation. Therefore, according to one specific embodiment of the present invention, the impregnation is a partial impregnation, preferably wherein the impregnation is a partial impregnation where the plant material receives a maximum of a 50% weight gain after the partial impregnation. A partial vacuum impregnation according to the present invention implies that not all of the air fraction is removed from the plant material tissue, i.e. just some part of the air inside of the plant material is replaced with solution. A partial impregnation may be preferable in some cases according to the present invention. Furthermore, as mentioned above, not all the parts of the plant material have to be impregnated. As an example, only leaves or some leaves may be enough to still have a very effective method according to the present invention. Also other parameters may vary. For example, different levels of the temperature may be used depending on the technical application.

As mentioned also other techniques may be used according to the present invention. According to one specific embodiment of the present invention, the active step for preventing microbial contamination involves an active treatment of the aqueous solution. Such an active treatment implies to apply a technology to ensure to kill any microbial growth in the solution. According to one specific embodiment of the present invention, the active treatment is a UV treatment. Such UV treatment or other types of active treatment to the aqueous solution may also be combined with adding one or more antimicrobial agents to the aqueous solution.

In addition to or instead of the antimicrobial agents, also other components may be added to the aqueous solution. As an example, according to one embodiment of the present invention, one or more growth agents are added to the aqueous solution. One example is different types of sugar components. Also other agents are possible to add, such as vitamins. Other examples are hormones, carbohydrates, minerals and/or pesticides. Fact is that any type of agents which may be introduced, can treat or affect the plant/flower tissue may be added. This is true for both soluble and insoluble agents. So, even if an aqueous solution is used in the method also insoluble agents may be used as additives in the method according to the present invention.

Also other steps may be of interest in the method according to the present invention. According to one specific embodiment of the present invention, the aqueous solution is recirculated and reused. It should be noted that such a step may also be combined with some of the other embodiments mentioned above. For example, an active treatment of the solution, such as a UV treatment step, may be arranged to be applied in a recirculation loop, i.e. in the recirculation step.

As mentioned above, the method according to the present invention comprises applying an electric field, i.e. using a PEF treatment. In the PEF treatment it is preferred to ensure a more or less uniform electric field. When treating plant or flower material, this material is sensitive to hot spots in the electric field. Such hot spots imply spaces where the electric field is intensive. Examples of positions which are risky in this regard are around the electrodes. Based on the above, according to one specific embodiment of the present invention, the pulsed electrical field (PEF) treatment involves applying an electric field between electrodes so that the electric field on edges of the electrodes amounts to a maximum of 50% when compared to the electric field level in a middle point or middle plane between the electrodes. Furthermore, the electrodes may also have certain features to support the creation of a uniform electric field. One example is electrodes with rounded edges. Such electrodes may be provided as oblong geometries on opposite sides and then with these rounded edges in the ends. Furthermore, if circular electrodes are used, such may be arranged so that only a semi-circular sphere of these are contactable inside of the PEF chamber where the actual electric field is created.

Moreover, the pulses used in the PEF treatment may be monopolar or bipolar, however bipolar pulses are preferred. Therefore, according to one specific embodiment of the present invention, the method involves using bipolar pulses in the PEF treatment.

Also other steps are possible. According to one specific embodiment of the present invention, a resting period is applied subsequent to the PEF treatment. This resting period may have a positive effect on the material after the PEF treatment before the drying step is applied. The resting period may also be seen as a pre-step or a preparation step before the drying step. In line with this, according to one specific embodiment of the present invention, the resting period is performed in a relative humidity of at least 60%, e.g. above 70%, above 80% or even above 90%, and in a temperature range of 4−10° C. This high humidity and temperature range is suitable for the material before entering into a drying step. This resting period ensures the plant material to regain structure stability when coming from a wet environment before being dried actively. Furthermore, according to yet another specific embodiment of the present invention, the resting period involves removing water from surfaces of the plant material. This may be performed manually, but preferably is performed by automatic means.

Moreover, according to yet another embodiment, the resting period involves putting the plant material on a net material to remove water from its surface. Also this step is a way of removing water from the material before actively drying the same.

In relation to the above it should be noted that to involve a resting period is voluntary in the method according to the present invention. In some cases storage, or packing and then storage, is performed directly after the drying step.

The method according to the present invention may also comprise an active storing step. According to one specific embodiment of the present invention, the method involves storing the plant material in a controlled storing environment. Furthermore, according to yet another embodiment, the storing environment involves a temperature of 4-10° C. According to the present invention it is possible to increase the shelf life of the plant material with and without freezing. The parameters to control in this step are e.g. temperature decrease, time and the absolute temperature. Based on the above, according to one specific embodiment of the present invention, the method involves a subsequent freezing step, such as a freezing step at a temperature range of between −30° C. and 0° C. In such a case then one or more of the substances mentioned above may function as a cryoprotectant.

Also in the storing step humidity may be relevant to control. Therefore, according to one specific embodiment of the present invention, the storing environment involves a humidity of above 50%, e.g. about 70% or even higher. Furthermore, according to yet another specific embodiment of the present invention, the storing is performed by incorporating the plant material into one or more package with modified atmosphere, e.g. into vacuum bags. Furthermore, according to another embodiment, the method also involves a cutting step performed during the resting period, after the resting period, before the storing or in connection to the start of the storing. This cutting step is preferable performed in a cold environment, such as e.g. in a temperature of 2-10° C. The cutting step according to the present invention normally at least comprises cutting stems of the plant material. Moreover, the cutting step is especially of relevance when performing the method on a flower material. In this context it should be mentioned that the present invention may be performed on any type of plant material, however flower materials are preferred. Therefore, according to one specific embodiment, the plant material comprises one or more sprouts, cuttings or cut flowers. All of these different plant material types are suitable for the method according to the present invention. In this regard it may be mentioned that the exact combinations of different steps and features according to the present invention, as disclosed above, may vary depending if the method is applied on sprouts or cut flowers or some other type of flower material, and also depending on the type of material in these different specific material groups.

### EXAMPLES

### Method

Cuttings of Pelargonium Interspecific Calliope Dark Red and Pelargonium Zonate Classic Diabolo arrived to our lab from Kenya or Ethiopia, 4 days after harvest. Cuttings were shipped with ice blocks, and the temperature on arrival was 12-14° C. Cuttings were treated immediately after arrival. Vacuum impregnation was applied in the first step. Cuttings were immersed in the aqueous solution of sugar. The solution had a temperature of 4-10° C. Immersed cuttings were placed in the vacuum chamber where the pressure was gradually decreased, and the total treatment time was 25 min. Cuttings were then removed from the vacuum chamber and subjected to the second treatment step, i.e. PEF (pulsed electric field).

Cuttings were placed in a PEF treatment chamber, which was filled with a conductive solution (adjusted by adding NaCl to reach 190-350 μS/cm), and the solution had temperature 4-10° C. Microseconds bipolar electric pulses were applied. Cuttings were taken out from the PEF chamber and washed in the tap water that had a temperature between 4-10° C. Cuttings were placed on a net (to avoid direct contact with water dropping from the plants) in a closed box for overnight resting. After resting cuttings were blotted with tissue paper and stored inside of plastic bags with 0.5 cm perforations for 7 days at 10° C.

Cuttings were planted in the greenhouse after storage was completed.

### RESULTS

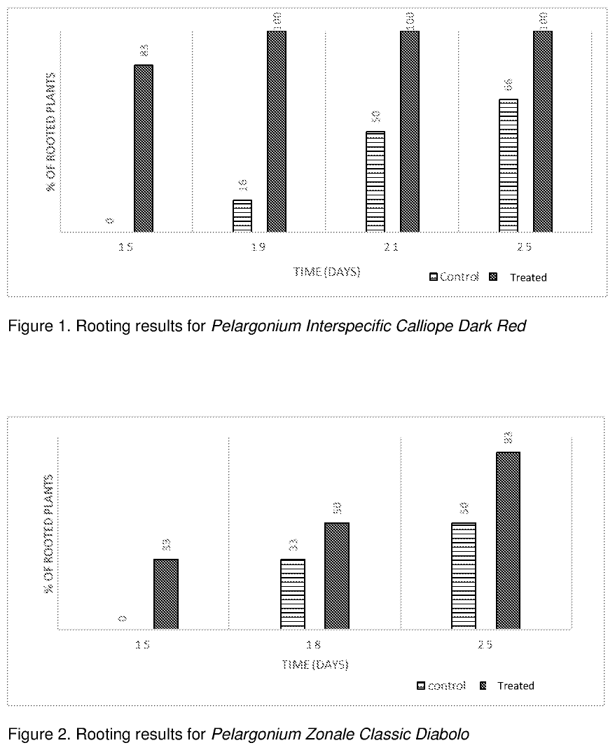

In FIG. 1 the rooting results for Pelargonium Interspecific Calliope Dark Red are presented. Rooting started on day 15 for the PEF treated sample while control plants rooted 4 days later, on day 19. The rooting percentage reached 100% for the treated plants while only 19% of the control plants rooted on day 19 of the trial.

In FIG. 2 the rooting results for Pelargonium Zonate Classic Diabolo are shown. Rooting started earlier for the PEF treated plants compared to the control plants (day 15 for treated and day 18 for control). The rooting percentage was also increased by the treatment, from 50% for control to 83% for the PEF treated plants (on day 25).

1-20. (canceled)

21. A method for treating a plant material, said method comprising the following steps:
exposing the plant material to vacuum impregnation in an aqueous solution;
said method also comprising an active step for preventing microbial contamination of the aqueous solution.

22. The method according to claim 21, wherein the vacuum impregnation is performed at a minimum pressure of 100 mbar.

23. The method according to claim 21, wherein the method also involves applying a drying step for removing water/moisture from surfaces of the plant material before packing the treated plant material.

24. The method according to claim 21, wherein the method involves applying a pulsed electrical field (PEF) treatment to the plant material in the aqueous solution before, simultaneously as or after exposing the plant material to vacuum impregnation in an aqueous solution.

25. The method according to claim 21, wherein the active step for preventing microbial contamination involves adding one or more antimicrobial agents to the aqueous solution.

26. The method according to claim 21, wherein the active step for preventing microbial contamination involves an active treatment of the aqueous solution.

27. The method according to claim 26, wherein the active treatment is a UV treatment.

28. The method according to claim 21, wherein the impregnation is a partial impregnation, preferably wherein the impregnation is a partial impregnation where the plant material receives a maximum of a 50% weight gain after the partial impregnation.

29. The method according to claim 21, wherein the aqueous solution comprises at least one additive of folic acid, gamma-aminobutyric acid (GABA), ethylene blockers, e.g. 1-methylcyclopropene (1-MCP), amino acids, e.g. cysteine, plant hormones, e.g. IBA, an antiseptic agent, e.g. silver nitrate, or a combination thereof.

30. The method according to claim 21, wherein one or more growth agents are added to the aqueous solution.

31. The method according to claim 21, wherein the aqueous solution is recirculated and reused.

32. The method according to claim 24, wherein the pulsed electrical field (PEF) treatment involves applying an electric field between electrodes so that the electric field on edges of the electrodes amounts to a maximum of 50% when compared to the electric field level in a middle point or middle plane between the electrodes.

33. The method according to claim 24, wherein a resting period is applied subsequent to the PEF treatment.

34. The method according to claim 33, wherein the resting period is performed in a relative humidity of at least 60% and in a temperature range of 4-10° C.

35. The method according to claim 33, wherein the resting period involves removing water from surfaces of the plant material.

36. The method according to claim 33, wherein the resting period involves putting the plant material on a net material to remove water from surfaces of the plant material.

37. The method according to claim 21, wherein the method involves a subsequent freezing step.

38. The method according to claim 21, wherein the method involves storing the plant material in a controlled storing environment.

39. The method according to claim 38, wherein the storing environment involves a temperature of 4-10° C.

40. The method according to claim 38, wherein the storing environment involves a humidity of above 50%.

41. The method according to claim 38, wherein the storing is performed by incorporating the plant material into one or more package with modified atmosphere.

42. The method according to claim 38, wherein the method also involves a cutting step performed during the resting period, after the resting period, before the storing or in connection to the start of the storing.

43. The method according to claim 21, wherein the plant material comprises one or more sprouts, cuttings or cut flowers.
